(19) United States
(12) Patent Application Publication
(10) Pub. No.: US 2025/0190206 A1
(43) Pub. Date: Jun. 12, 2025

(54) IN-VEHICLE DEVICE, PROGRAM, AND PROGRAM UPDATING METHOD

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventors: Takayuki SHIOZAWA, Yokkaichi-Shi, Mie (JP); Ken FURUTO, Yokkaichi-Shi, Mie (JP); Hiroshi TATEISHI, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/844,699

(22) PCT Filed: Feb. 17, 2023
(86) PCT No.: PCT/JP2023/005620

§ 371 Date: Sep. 6, 2024

(30) Foreign Application Priority Data
Mar. 9, 2022 (JP) 2022-036515

(51) Int. Cl. G06F 8/65; B60R 16/023

(52) U.S. Cl. CPC G06F 8/65; B60R 16/023

(57) ABSTRACT

An in-vehicle device according to one aspect of the present disclosure is an in-vehicle device communicably connected to an update device that executes processing for updating a program of an in-vehicle ECU mounted on a vehicle with an update program acquired from an external server outside the vehicle, the in-vehicle device including a control unit configured to execute processing for updating a program in the update device, in which the control unit proxies at least a part of the processing for updating the program, which is executed in the update device when the update device is included in a target to be updated by the update program.

### CROSS-REFERENCE TO RELATED APPLICATIONS

This application is the U.S. national stage of PCT/JP2023/005620 filed on Feb. 17, 2023, which claims priority of Japanese Patent Application No. JP 2022-036515 filed on Mar. 9, 2022, the contents of which are incorporated herein.

### TECHNICAL FIELD

The present disclosure relates to an in-vehicle device, a program, and a program updating method.

### BACKGROUND

Vehicles are equipped with an electronic control unit (ECU) for controlling in-vehicle equipment such as drive control systems such as engine control, and body systems such as air conditioning control. The ECU includes an arithmetic processing unit such as an MPU, a rewritable non-volatile storage unit such as an EEPROM, and a communication unit for communicating with other ECUs, and controls the in-vehicle equipment by reading and executing a control program stored in the storage unit. The vehicle is further equipped with a communication device (an update device) with wireless communication capabilities, and can communicate via the communication device with a program providing device connected to a network outside the vehicle, download and receive a control program of the ECU from the program providing device, and update the control program of the ECU (see, for example, JP 2017-097851 A).

However, in JP 2017-097851 A, there is a problem in that no consideration is given to processing of updating the control program itself applied to the communication device (update device).

An object of the present disclosure is to provide an in-vehicle device and the like that can efficiently execute program update processing when the update device that executes processing for updating the program of the in-vehicle ECU executes the processing for updating the program applied to the update device itself.

### SUMMARY

An in-vehicle device according to one aspect of the present disclosure is an in-vehicle device communicably connected to an update device that executes processing for updating a program of an in-vehicle ECU mounted on a vehicle with an update program acquired from an external server outside the vehicle, the in-vehicle device including a control unit configured to execute processing for updating a program in the update device, in which the control unit proxies at least a part of the processing for updating the program, which is executed in the update device when the update device is included in a target to be updated by the update program.

### Effects

According to one aspect of the present disclosure, it is possible to provide an in-vehicle device and the like that can efficiently execute the program update processing when the update device that executes the processing for updating the program of the in-vehicle ECU executes the processing for updating the program applied to the update device itself.

### BRIEF DESCRIPTION OF DRAWINGS

FIG. 1 is a schematic diagram illustrating an example of a configuration of an in-vehicle update system according to a first embodiment.

FIG. 2 is a block diagram illustrating an example of a physical configuration of a proxy ECU.

FIG. 3 is an explanatory diagram illustrating an example of vehicle configuration information.

FIG. 4 is an explanatory diagram illustrating an example of state transitions of an update device, an in-vehicle ECU and a proxy ECU to be updated, and the like in program update processing according to the first embodiment.

FIG. 5 is an explanatory diagram illustrating an example of a processing flow (sequence) by the update device, the in-vehicle ECU and the proxy ECU to be updated, and the like according to the first embodiment.

FIG. 6 is a flowchart illustrating an example of processing by a control unit of the proxy ECU and a control unit of the update device according to the first embodiment.

FIG. 7 is a schematic diagram illustrating an example of the configuration of the in-vehicle update system according to a second embodiment.

FIG. 8 is an explanatory diagram illustrating an example of the state transitions of the update device, the in-vehicle ECU and the proxy ECU to be updated, and the like in the program update processing according to the second embodiment.

FIG. 9 is an explanatory diagram illustrating an example of the processing flow (sequence) by the update device, the in-vehicle ECU and the proxy ECU to be updated, and the like according to the second embodiment.

FIG. 10 is a flowchart illustrating an example of the processing of the control unit of the proxy ECU and the control unit of the update device according to the second embodiment.

### DETAILED DESCRIPTION OF PREFERRED EMBODIMENTS

First, embodiments of the present disclosure will be listed and described. Further, at least some of the embodiments described below may be combined freely.

An in-vehicle device according to one aspect of the present disclosure is an in-vehicle device communicably connected to an update device that executes processing for updating a program of an in-vehicle ECU mounted on a vehicle with an update program acquired from an external server outside the vehicle, the in-vehicle device including a control unit configured to execute processing for updating a program in the update device, in which the control unit executes proxy processing of at least a part of the processing executed in the update device when the update device is included in a target to be updated by the update program.

In such an aspect, the control unit of the in-vehicle device (a proxy ECU) executes the proxy processing of the update device and can instruct the update device to execute processing related to updating the update device itself (its own device). The update device can execute the processing related to updating a program for its own device based on an instruction from the in-vehicle device (the proxy ECU). That is, when the update device updates its own device (the update device itself), there is a concern that the processing content, such as a determination branch, is complicated during an update, however, since the update device causes the in-vehicle device (proxy ECU) to take charge of program update (application of the update program and the like) in the update device itself, it is possible to smoothly execute program update processing in the update device.

In the in-vehicle device according to one aspect of the present disclosure, the proxy processing includes activation processing for applying the update program acquired by the update device to the update device itself.

In this aspect, when the update device itself is an update target, since the update device is activated based on the instruction from the in-vehicle device (proxy ECU), the processing related to the update can be executed smoothly.

In the in-vehicle device according to one aspect of the present disclosure, the proxy processing includes rollback processing depending on a result of activation processing.

In such an aspect, after the update device executes the activation processing in response to an activation instruction from the in-vehicle device (proxy ECU), the in-vehicle device (proxy ECU) executes processing (abnormality detection sequence) such as operation check on the update device after the activation processing (after application of the update program). When the in-vehicle device (proxy ECU) detects an abnormality in the update device after the activation processing, it transmits (outputs) a rollback instruction to the update device. The update device that acquires the rollback instruction from the in-vehicle device (proxy ECU) executes the rollback processing to revert to an original program before the update program is applied, so that even when the activation processing fails, the update device can execute the original program, and when the update device has a function for performing control on the vehicle, it can continue the control on the vehicle.

In the in-vehicle device according to one aspect of the present disclosure, a storage unit of the update device stores in advance information for identifying the in-vehicle device as a proxy ECU that executes the proxy processing.

In such an aspect, the in-vehicle device (proxy ECU) is identified by an ECU-ID, an IP address, or the like, or a CAN-ID (which may substantially identify the in-vehicle device by a message ID) for communicating with the in-vehicle device (proxy ECU). Regardless of the in-vehicle ECU that is a target of the update program, by pre-determining as one ECU (proxy ECU) the in-vehicle device that proxies the processing of the update device (by fixedly setting the proxy ECU), the update device does not need to decide (select) each time which ECU will be the in-vehicle device that proxies the processing of the update device, and it is possible to quickly start the update processing for the update device. Further, since it is sufficient that only one ECU has a function as the in-vehicle device (proxy ECU) that proxies the processing of the update device, it is possible to reduce memory consumption of other in-vehicle ECUs.

In the in-vehicle device according to one aspect of the present disclosure, the control unit acquires an instruction signal indicating an instruction to execute the proxy processing from the update device, and starts the proxy processing in response to the acquired instruction signal.

In such an aspect, the control unit of the in-vehicle device (proxy ECU) proxies the processing executed by the update device only when it acquires the instruction signal (a proxy instruction signal) indicating the instruction to execute the proxy processing for the in-vehicle device (proxy ECU) from the update device. The update device executes the update processing of the in-vehicle ECU by itself when its own device is not the update target, and can cause the in-vehicle device (proxy ECU) to proxy the update processing only when its own device is the update target. The in-vehicle device (proxy ECU) does not execute the processing on behalf of the update device every time the update device acquires the update program, but proxies the processing of the update device only when the update device is the update target, so that it is possible to execute the update processing efficiently without unnecessarily proxying the processing of the update device.

In the in-vehicle device according to one aspect of the present disclosure, the proxy processing includes processing for updating the program of the in-vehicle ECU, the update device has a relay function for relaying data transmitted and received between in-vehicle ECUs, and the control unit changes the processing for updating the program of the in-vehicle ECU depending on whether the update device maintains the relay function when the update device is included in the target to be updated by the update program.

In such an aspect, when the update device is included in the target to be updated by the update program, that is, while the update device is processing to update the program of its own device, the control unit of the in-vehicle device (proxy ECU) determines whether the update device maintains the relay function, and changes the processing for updating the program of the in-vehicle ECU depending on a determination result. Therefore, even when the processing proxied by the control unit includes the processing for updating the program of the in-vehicle ECU, different processing can be executed on the in-vehicle ECU that is the update target depending on whether the relay function by the update device is maintained, and appropriate proxy processing can be executed according to the update processing for the update device. That is, when the update device maintains the relay function, the in-vehicle device (proxy ECU) can directly instruct the in-vehicle ECU to execute the activation processing or the rollback processing. Since the in-vehicle device (proxy ECU) can cause the update device and the in-vehicle ECU to simultaneously execute the activation processing or the rollback processing, the processing related to the update can be executed quickly by one-stage processing.

In the in-vehicle device according to one aspect of the present disclosure, the update device is connected to a communication line on the external server side and a communication line on the in-vehicle ECU side, and the in-vehicle device is connected to the communication line on the external server side.

In such an aspect, the in-vehicle device (proxy ECU) is connected to the communication line on the external server side, so that the update program transmitted from the external server can be acquired without going through the update device. In this way, the in-vehicle device (proxy ECU) connected to the communication line on the external server side may also function as a device provided between the external server and the update device, such as an out-vehicle communication device that communicates with the external server or a security device that monitors unauthorized communications.

In the in-vehicle device according to one aspect of the present disclosure, the control unit acquires the update program from the external server without going through the update device, and outputs a request signal to request the update device to start the proxy processing based on the acquired update program.

In such an aspect, the in-vehicle device (proxy ECU) acquires the update program without going through the update device, so that it is possible to determine whether the update device is the update target, independently (separately) from the processing by the update device. Therefore, when the update device is the update target, the update device can transmit the instruction signal (proxy instruction signal) instructing the in-vehicle device (proxy ECU) to execute the proxy processing in response to the request signal from the in-vehicle device (proxy ECU). Since the in-vehicle device (proxy ECU) acquires the update program before the update device, it is possible to determine whether the update device is the update target. When the update device is the update target, since the update device can instruct the in-vehicle ECU to execute the activation processing, and then transmit the instruction signal (proxy instruction signal) instructing the in-vehicle device (proxy ECU) to execute the proxy processing based on the request signal, there is no need for the update device itself to determine whether to transmit the proxy instruction signal to the in-vehicle device (proxy ECU), and the update device can quickly hand over the processing to the in-vehicle device (proxy ECU).

In the in-vehicle device according to one aspect of the present disclosure, the communication line on the external server side is connected to an out-vehicle communication device for wireless communication with the external server, and the in-vehicle device is included in the out-vehicle communication device.

In such an aspect, the in-vehicle device may be included in the out-vehicle communication device, that is, configured as a part of the out-vehicle communication device. By incorporating the in-vehicle device in the out-vehicle communication device in this way, these devices can be stored in the same housing, and it is possible to reduce weight and size compared to when the out-vehicle. communication device and the in-vehicle device are configured as separate entities.

A program according to one aspect of the present disclosure causes a computer communicably connected to an update device that executes processing for updating a program of an in-vehicle ECU mounted on a vehicle with an update program acquired from an external server outside the vehicle to execute processing for updating a program in the update device, and execute processing for proxying at least a part of the processing for updating the program, which is executed in the update device when the update device is included in a target to be updated by the update program.

In such an aspect, since the update device causes the in-vehicle device (proxy ECU) to take charge of the program update (such as application of the update program) in the update device itself, it is possible to smoothly execute the program update processing in the update device.

A program updating method according to one aspect of the present disclosure causes a computer communicably connected to an update device that executes processing for updating a program of an in-vehicle ECU mounted on a vehicle with an update program acquired from an external server outside the vehicle to execute processing for updating a program in the update device, and execute processing for proxying at least a part of the processing for updating the program, which is executed in the update device when the update device is included in a target to be updated by the update program.

In such an aspect, since the update device causes the in-vehicle device (proxy ECU) to take charge of the program update (such as application of the update program) in the update device itself, it is possible to smoothly execute the program update processing in the update device.

### Details of Embodiments of the Present Disclosure

The present disclosure will be specifically described based on the drawings illustrating the embodiments of the present disclosure. An update device 3 according to the embodiments of the present disclosure will be described below with reference to the drawings. Note that the present disclosure is not limited to these illustrations, but is set forth in the claims, and is intended to include all modifications within the meaning and scope equivalent to the claims.

### First Embodiment

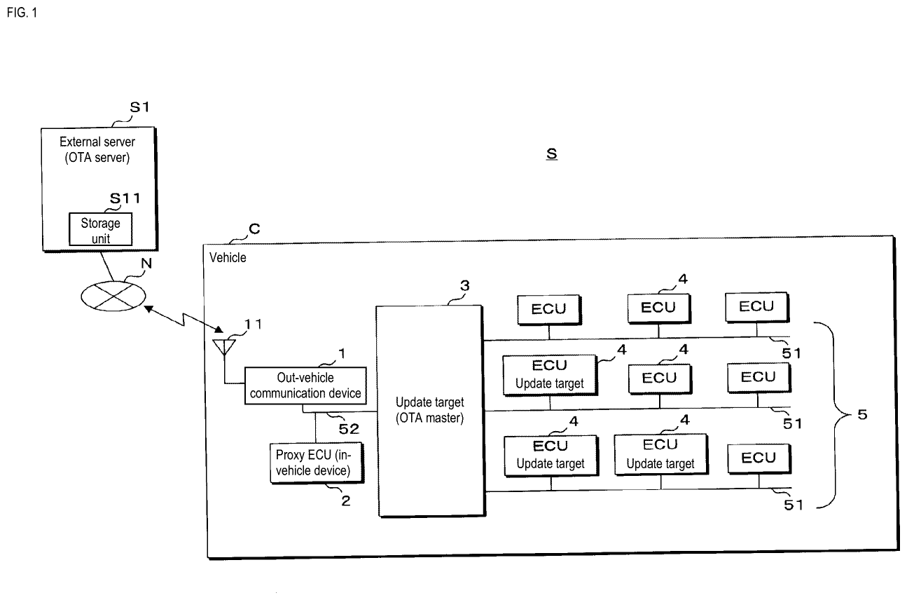

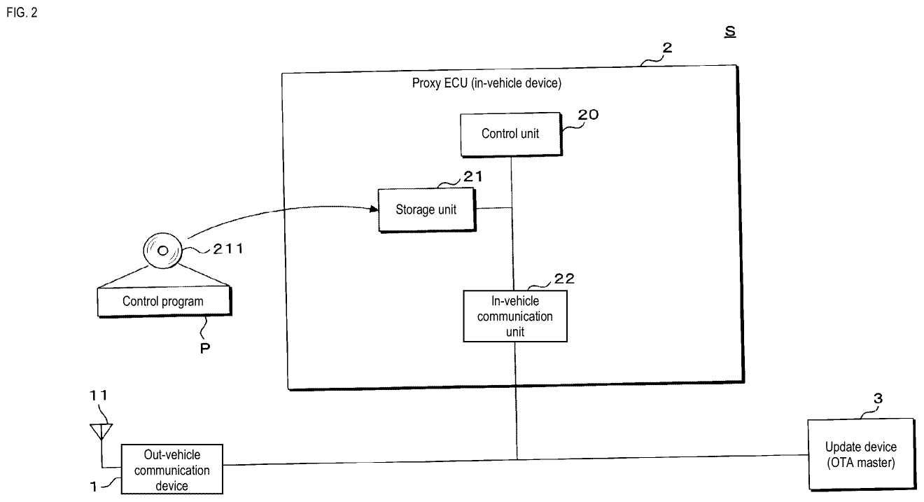

An embodiment will be described below with reference to the drawings. FIG. 1 is a schematic diagram illustrating a configuration of an in-vehicle update system S according to a first embodiment. FIG. 2 is a block diagram illustrating an example of a physical configuration of a proxy ECU 2. The in-vehicle update system S includes an out-vehicle communication device 1 and an update device 3 mounted on a vehicle C, and transmits the update program acquired from an external server S1 (a program providing device, an OTA server) connected via an out-vehicle network N to an in-vehicle electronic control unit (ECU) 4 mounted on the vehicle C. Further, the in-vehicle update system S includes a communication line (an in-vehicle side communication line 51) on the in-vehicle ECU side connected to the update device 3 and the in-vehicle ECU, and a communication line (an out-vehicle side communication line 52) on the external server side connected to the update device 3 and the out-vehicle communication device, and the in-vehicle device (proxy ECU 2) that proxies the processing of the update device 3 is connected to the out-vehicle side communication line 52.

The external server S1 is a computer such as a server connected to the out-vehicle network N such as the Internet or a public line network, includes a storage unit S11 such as a random access memory (RAM), a read only memory (ROM) or a hard disk, and corresponds to the program providing device outside the vehicle. The external server S1 stores in the storage unit S11 a program or data for controlling the in-vehicle ECU 4, created by a manufacturer of the in-vehicle ECU 4, or the like. The program or data is transmitted to the vehicle C as the update program, as described below, and are used to update the program or data of the in-vehicle ECU 4 mounted on the vehicle C. The external server S1 (program providing device) configured in this manner is also called an over the air (OTA) server.

The proxy ECU 2 is connected to the out-vehicle side communication line 52 and can acquire the update program transmitted from the external server S1 without going through the update device 3. The proxy ECU 2 determines whether the update device 3 is the update target based on the acquired update program. When the update device 3 is the update target, the proxy ECU 2 outputs a request signal for requesting the update device to start the proxy processing for the update device 3. In response to the proxy instruction signal transmitted from the update device 3, the proxy ECU 2 issues the activation instruction to the update device 3, performs the operation check in the update device 3 after the activation processing, and issues the rollback instruction when an operational defect is detected.

The update device 3 functions as an OTA master that transmits the update program acquired from the external server S1 to the in-vehicle ECU 4 to be updated, and transmits the activation instruction to apply the transmitted update program to the in-vehicle ECU 4. When applying the update program to (executing the activation processing for) the update device itself, the update device 3 functioning as the OTA master transmits to the proxy ECU 2 the proxy instruction signal indicating the instruction to execute the proxy processing for the update device 3, and executes the activation processing or the rollback processing according to the instruction from the proxy ECU 2. The in-vehicle ECU 4 mounted on the vehicle C acquires the update program transmitted by wireless communication from the external server S1 via the update device 3, and applies the update program (executes the activation processing) according to the activation instruction, to update (reprogram) the program executed by its own ECU.

Hereinafter, the program will be described as including program code including control syntax and the like for processing by the in-vehicle ECU 4, and an external file in which data to be referenced is described when executing the program code. When transmitting the update program, the external file in which the program code and the data are described is transmitted from the external server S1, for example as an encrypted archive file. When transmitting the update program, the external server S1 generates a package including the update program and transmits the generated package to the vehicle C. The package includes, for example, package information (campaign information) that is information on the program update, information (target information) related to the in-vehicle ECU 4 that is the update target, and the update program to be applied to the in-vehicle ECU 4 to be updated.

The vehicle C is equipped with the out-vehicle communication device 1, the update device 3, a display device (not illustrated), and a plurality of ECUs 4 for controlling various in-vehicle equipment. The out-vehicle communication device 1 and the update device 3 are communicatively connected by a harness such as a serial cable. The update device 3 and the in-vehicle ECUs 4 are communicatively connected via an in-vehicle network 5 compatible with a communication protocol such as Control Area Network (CAN) or Ethernet (registered trademark).

The out-vehicle communication device 1 includes an out-vehicle communication unit (not illustrated) and an input/output interface (I/F) (not illustrated) for communicating with the update device 3. The out-vehicle communication unit is a communication device for wireless communication using a mobile communication protocol such as LTE (registered trademark), 4G, 5G, or WiFi (registered trademark), and transmits and receives data to and from the external server S1 via an antenna 11 connected to the out-vehicle communication unit. The communication between the out-vehicle communication device 1 and the external server S1 is performed, for example, via the out-vehicle network N such as the public line network or the Internet.

The input/output I/F of the out-vehicle communication device 1 is, for example, a communication interface for serial communication with the update device 3. The out-vehicle communication device 1 and the update device 3 communicate with each other via the harness such as the serial cable connected between input/output I/Fs. In the present embodiment, the out-vehicle communication device 1 is a separate device from the update device 3, and these devices are communicatively connected via the input/output I/F or the like, but this is not limited to the above. The out-vehicle communication device 1 may be incorporated into the update device 3 as one component of the update device 3. Alternatively, the out-vehicle communication device 1 and the update device 3 may be connected via the in-vehicle network 5 such as CAN.

The proxy ECU 2 includes a control unit 20, a storage unit 21, and an in-vehicle communication unit 22. The proxy ECU 2 functions, for example, as the security device that monitors unauthorized communications, except when the proxy instruction signal is transmitted from the update device 3. Note that the proxy ECU 2 may be incorporated into the out-vehicle communication device 1 as one component of the out-vehicle communication device 1.

The control unit 20 of the proxy ECU 2 includes a central processing unit (CPU), a micro processing unit (an MPU), or the like and is configured to execute various control processing, arithmetic processing, or the like by reading and executing a control program P (program product) and data pre-stored in the storage unit.

The storage unit 21 of the epoxy ECU 2 includes a volatile memory element such as a random access memory (RAM) or a non-volatile memory element such as a read only memory (ROM), an electrically erasable programmable ROM (EEPROM), or a flash memory. The storage unit 21 stores the control program of the proxy ECU 2. The storage unit 21 also stores the update program acquired from the external server S1. The control program P (program product) stored in the storage unit 21 may be a control program P (program product) read from a readable storage medium 211 and stored by the update device 3. The control program P may also be a control program P downloaded from an external computer (not illustrated) connected to a communication network (not illustrated) and stored in the storage unit. The storage unit 21 of the proxy ECU 2 may also store a flag value, a setting file, or the like indicating that the proxy ECU 2 itself is an ECU having an epoxy function.

The in-vehicle communication unit 22 is, for example, an input/output interface that uses a communication protocol such as CAN or Ethernet (registered trademark), and the control unit mutually communicates with the out-vehicle communication device 1 or the update device 3 connected to the out-vehicle side communication line 52 via the in-vehicle communication unit 22.

The update device 3 includes a control unit, storage units (a first storage unit and a second storage unit), an input/output I/F, and an in-vehicle communication unit (all not illustrated). The update device 3 is configured to acquire from the out-vehicle communication device 1 the update program (package) that the out-vehicle communication device 1 has received from the external server S1 via wireless communication, and to transmit the update program to a predetermined in-vehicle ECU 4 (the in-vehicle ECU 4 to be updated) via the in-vehicle network 5. That is, the update device 3 functions as the OTA master (a reprogramming master) that controls the program update in the in-vehicle ECU 4 to be updated.

The update device 3 is a gateway (an in-vehicle relay device) that manages buses (segments) of a plurality of systems such as the in-vehicle ECU 4 of a control system, the in-vehicle ECU 4 of a safety system, and the in-vehicle ECU 4 of a body system, and relays communication between the in-vehicle ECUs 4 between the buses (segments). That is, the update device 3 is connected to each of in-vehicle side communication lines 51 that constitute the plurality of buses (segments), and the in-vehicle network 5 is constituted by the plurality of in-vehicle side communication lines 51 (segments) collected by the update device 3. The update device 3 functions as a CAN gateway in relaying CAN protocol, and functions as a layer 2 switch or a layer 3 switch in relaying TCP/IP protocol. The update device 3 may be a power lan box (PLB) that functions as a power distribution device that distributes and relays power output from a power supply device such as a secondary battery and supplies power to the in-vehicle equipment such as an actuator connected to the update device itself, in addition to relaying communication. Alternatively, the update device 3 may be configured as one functional part of a body ECU that controls the entire vehicle C. Alternatively, the update device 3 may be an integrated ECU that is constituted by a central control device such as a vehicle computer and performs overall control of the vehicle C.

The control unit of the update device 3 includes a central processing unit (CPU), a micro processing unit (an MPU), or the like, and is configured to execute various control processing, arithmetic processing, or the like by reading and executing the control program and the data of the update device 3 that are pre-stored in the storage unit.

The storage unit of the update device 3 includes two storage areas of a first storage unit and a second storage unit, and each of the first storage unit and the second storage unit includes a volatile memory element such as a random access memory (RAM) or a non-volatile memory element such as a read only memory (ROM), an electrically erasable programmable ROM (EEPROM), or a flash memory. The first storage unit and the second storage unit store a control program and data to be referenced during processing in advance. The control program is an object to be updated by the update program acquired from the external server S1. The control program stored in the storage unit (the first storage unit and the second storage unit) may be a control program (program product) read from the readable storage medium and stored by the update device 3. Note that the control program may be downloaded from the external computer (not illustrated) connected to the communication network (not illustrated) and stored in the storage unit. In addition, the storage unit of the update device 3 may store the ECU-ID, the IP address, or the like that identifies the proxy ECU, or a CAN-ID (which may substantially identify the in-vehicle device by the message ID) or the like for communicating with the in-vehicle device (proxy ECU).

The storage unit (the first storage unit and the second storage unit) of the update device 3 stores information about versions of two programs (control programs of the update device 3) of a current version and an old version, and information about an area (operation side) in which the control program currently being executed (applied) is stored. That is, when the control program stored in the first storage unit (a first side) is currently being executed, the first storage unit stores that the operation side is the first storage unit (the first side). In this case, it is stored that a non-operation side is the second storage unit (a second side). The first storage unit, which is the operation side, stores the current version of the control program. The second storage unit, which is the non-operation side, stores the old version of the control program. Alternatively, the second storage unit, which is the non-operation side, may be a storage area that does not store the old version of the control program and the like, and is free space. In this way, the non-operation side is in a state in which the storage area of free space, the old version of the control program, or the like is stored, so that it is possible to ensure a state in which the old version can be restored by writing a new version of the control program to the non-operation side during update.

The input/output I/F of the update device 3 is, for example, a communication interface for serial communication, similar to the input/output I/F of the out-vehicle communication device 1. The update device 3 is communicatively connected to the display device and an IG switch (not illustrated) via the input/output I/F.

The in-vehicle communication unit of the update device 3 is an input/output interface using a communication protocol such as CAN or Ethernet (registered trademark), and the control unit mutually communicates with the in-vehicle equipment such as the in-vehicle ECU 4 or other relay devices connected to the in-vehicle network 5 via the in-vehicle communication unit. A plurality of the in-vehicle communication units (four in the present embodiment) are provided, and three of the four in-vehicle communication units are each connected to the in-vehicle side communication line 51 (the segment) that constitutes the in-vehicle network 5. By providing the plurality of in-vehicle communication units in this manner, the in-vehicle network 5 is divided into the plurality of segments, and an individual in-vehicle ECU 4 is connected to each segment, for example, depending on functions (control system function, safety system function, and body system function) of the in-vehicle ECU 4. Of the four in-vehicle communication units, an in-vehicle communication unit to which the in-vehicle side communication line is not connected is connected to the out-vehicle side communication line 52, and the in-vehicle communication unit mutually communicates with the out-vehicle communication device 1 or the proxy ECU 2 via the out-vehicle side communication line 52.

The in-vehicle ECU 4 includes a control unit, a storage unit, and an in-vehicle communication unit (not illustrated), similar to the proxy ECU 2. The storage unit includes a volatile memory element such as a random access memory (RAM) or a non-volatile memory element such as a read only memory (ROM), an electrically erasable programmable ROM (EEPROM), or a flash memory, and stores the program or data of the in-vehicle ECU 4. Note that the storage unit of the in-vehicle ECU 4 includes two storage areas of a first storage unit and a second storage unit, similar to the storage unit of the update device 3. This program or data is the object to be updated by the update program transmitted from the program providing device and relayed by the update device 3. Like the update device 3, the in-vehicle communication unit of the in-vehicle ECU 4 includes, for example, a CAN transceiver or an Ethernet PHY unit, and communicates with the update device 3 via the in-vehicle communication unit.

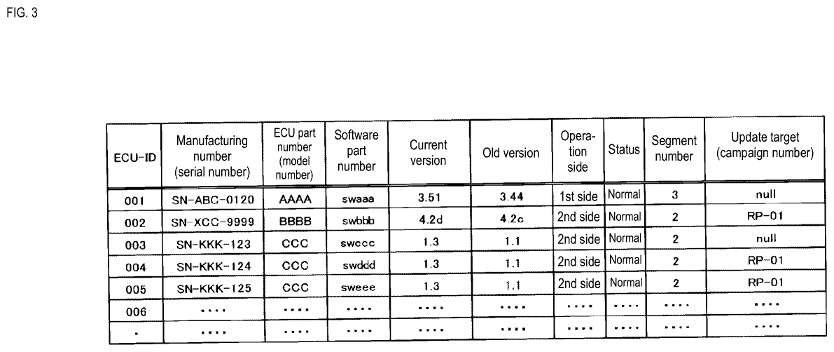

FIG. 3 is an explanatory diagram illustrating an example of vehicle configuration information. The update device 3 communicates with all in-vehicle ECUs 4 mounted on the vehicle C (own vehicle) periodically, cyclically, or steadily, and acquires information on these in-vehicle ECUs 4. For example, when the IG switch is turned on or off, or at a predetermined timing, the update device 3 steadily requests all the in-vehicle ECUs 4 or a specific in-vehicle ECU 4 mounted on the vehicle C, to transmit configuration information of its own ECU and an update history of the configuration information. The update device 3 acquires the configuration information and update history transmitted from each of the in-vehicle ECUs 4, aggregates the configuration information and the like, and stores the aggregated configuration information and update history as the vehicle configuration information.

The update device 3 may acquire and aggregate the configuration information and update history autonomously transmitted by each of the in-vehicle ECUs 4, without requesting the in-vehicle ECUs 4 to transmit the configuration information and update history, and store them in the storage unit. Alternatively, the update device 3 may transmit the update program to the in-vehicle ECU 4, and change the configuration information (the vehicle configuration information) based on the transmitted update program each time the transmission is completed. The update device 3 generates the vehicle configuration information, for example in a table format, by aggregating information related to the individual in-vehicle ECU 4 acquired from the plurality of in-vehicle ECUs 4, and stores it in the storage unit of its own device. The storage unit that stores the vehicle configuration information may be the first storage unit, the second storage unit, or the storage unit that stores the information redundantly in both the first storage unit and the second storage unit.

As an example, the vehicle configuration information stored in the table format includes, as management items (fields), for example, a manufacturing number (serial number) of the in-vehicle ECU 4, an ECU part number (a model number), a software part number, a current program version, an old program version, an operation side, a status (reprogramming status), a segment number, and an update target (a campaign number), and is managed in association with the ECU-ID, which is a sequential number or the like set so as not to overlap with each other in the individual in-vehicle ECU 4. The management item of the ECU-ID stores an identification number such as a sequential number for uniquely identifying the in-vehicle ECU 4, in all the in-vehicle ECUs 4 mounted on the vehicle C. Furthermore, the vehicle configuration information may include, as the management items (fields), a media access control (MAC) address and IP address of the in-vehicle ECU 4.

The manufacturing number (serial number) is a number assigned to the in-vehicle ECU 4 when manufactured, and includes a lot number indicating a production base and the like, a sequential number at the time of manufacturing, and the like, and is a unique number that can uniquely identify the ECU. The ECU part number (the model number) is a number that identifies the type of in-vehicle ECU 4, and is for example, a component number. The software part number is a number for identifying the software type of the update program (the control program P that is the update target). The update device 3 may identify the in-vehicle ECU 4 to be updated among the in-vehicle ECUs 4 mounted on the own vehicle by comparing the manufacturing number or the ECU part number included in the target information acquired from the external server S1 with the manufacturing number or the ECU part number included in the vehicle configuration information.

The current version is a version number of the program currently being executed (applied) by the in-vehicle ECU 4, and is the version number of the program stored in the operation side. The old version is a version number of the program previously executed (applied) by the in-vehicle ECU 4, and is the version number of the program stored in the non-operation side (the storage area that is not the operation side). The operation side is information that identifies one of the storage areas (first side: first storage unit or second side: second storage unit) in which the program currently being executed (applied) by the in-vehicle ECU 4 is stored. The operation side and version information are stored to be used when rolling back from the new version of the program written during the update to the old version of the program.

The management item of the status stores status information (reprogramming status) on the application of the update program in the corresponding in-vehicle ECU 4 (ECU-ID of the same record). The update device 3 may update the status (the management item of the status) of the individual in-vehicle ECU 4 by communicating with the in-vehicle ECU 4 to which an activation command is transmitted and obtaining the status information (reprogramming status) of the in-vehicle ECU 4. This allows the update device 3 to aggregate, store, and manage the status information (reprogramming status) of each in-vehicle ECU 4 after the activation processing. The update device 3 may refer to or update these data when installing the new version of the program during the update, when activating, and when executing rollback processing.

The management item of the segment number stores the number of the in-vehicle side communication line 51 (segment) to which the corresponding in-vehicle ECU 4 is connected. The number of the in-vehicle side communication line 51 (segment) corresponds to a number (a communication port number) of each of the plurality of in-vehicle communication units included in the update device 3. This allows the update device 3 to identify the individual in-vehicle ECU 4 that is directly connected to each of the in-vehicle communication units 22 in the update device itself via the in-vehicle side communication line 51 (segment).

The management item of the update target (campaign number) stores, for example, a campaign number for the in-vehicle ECU 4 that is the target of the current update (campaign). For example, when executing a group update in which the plurality of in-vehicle ECUs 4 are updated simultaneously, it is necessary to determine consistency for a set of versions of the plurality of in-vehicle ECUs 4 that are the update target (campaign target). In response, for all in-vehicle ECUs 4 mounted on the vehicle C, a field of the in-vehicle ECU 4 that is the target of the current update (campaign) stores the number of the campaign, so that it possible to efficiently identify the in-vehicle ECU 4 that is the update target. As illustrated in the figure in the present embodiment, the field of the in-vehicle ECU 4 that is not the update target may be, for example, blank (a null value may be stored). Furthermore, information (ECU part number, software version, and the like) on the plurality of in-vehicle ECUs 4 for which the campaign number is stored in the field of the update target may be extracted and list management or the like may be performed in a separate table.

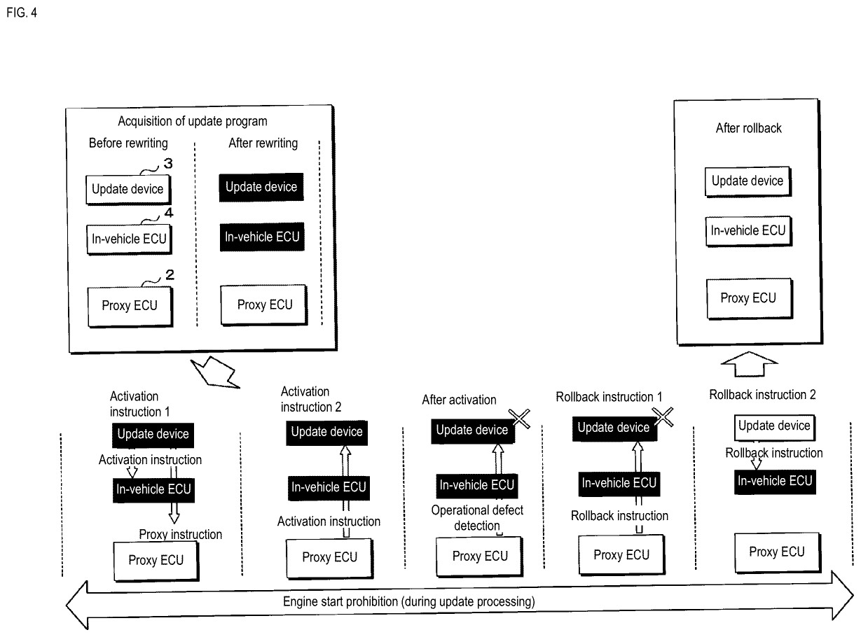

FIG. 4 is an explanatory diagram illustrating an example of state transitions of the update device 3, the in-vehicle ECU 4 and the proxy ECU 2 to be updated, and the like in the program update processing according to the first embodiment. In the update device 3 and the in-vehicle ECU 4 to be updated, states before and after the update program is stored are illustrated in inverted display form.

In a state before the update program is stored (before rewriting), the update device 3 and the in-vehicle ECU 4 execute the control program P stored in their operation sides. Since the update device 3 stores the update program for its own device acquired from the external server S1 on the non-operation side of its own device, and transmits the update program for the in-vehicle ECU 4 to the in-vehicle ECU 4, the update program is stored in the non-operation sides of the update device 3 and the in-vehicle ECU 4.

The update device 3 transmits the proxy instruction to the proxy ECU 2 and transmits the activation instruction to the in-vehicle ECU 4 to be updated. In response to the proxy instruction, the proxy ECU 2 starts a processing sequence and transmits the activation instruction to the update device 3. After transmitting the activation instruction, the proxy ECU 2 detects whether there is an operational defect in the update device 3 that has executed the activation processing.

When the proxy ECU 2 detects the operational defect in the update device 3 after the activation processing (operational defect: present), it transmits the rollback instruction to the update device 3. The update device 3 that receives the rollback instruction from the proxy ECU 2 executes the rollback processing by executing the original program before the update program was applied. The update device 3 that executes the rollback processing and executes the original program before the update program was applied transmits the rollback instruction to the in-vehicle ECU 4 to be updated. Note that when the update device 3 retains a communication relay function even during the update processing, the proxy ECU 2 may transmit the rollback instruction to the in-vehicle ECU 4 via the relay function of the update device 3.

The update device 3 that received the rollback instruction from the proxy ECU 2 executes the rollback processing by executing the original program before the update program was applied. Thus, the update device 3 and the in-vehicle ECU 4 execute the original program before the update program was applied.

In this way, by executing the activation processing and rollback processing in the update device 3 by the proxy ECU 2, the activation processing and rollback processing are executed in two stages on the update device 3 and in-vehicle ECU 4 that are the update targets. On the other hand, a series of processing related to updating the programs in the update device 3 and in-vehicle ECU 4 are executed during a period when the vehicle C is prohibited from being in an activated state, such as a period when engine start or traction motor drive is prohibited. By executing the series of processing during the prohibited period, it possible to prevent, for example, the engine from being started, in a state where a temporary inconsistency (version difference) has occurred between the applied programs. When executing the series of processing related to the update program during a period when the vehicle C is prohibited from being in the activated state, the update device 3 may temporarily disable an on-signal output from the IG switch via the input/output I/F or the like, by executing, for example, masking processing or the like.

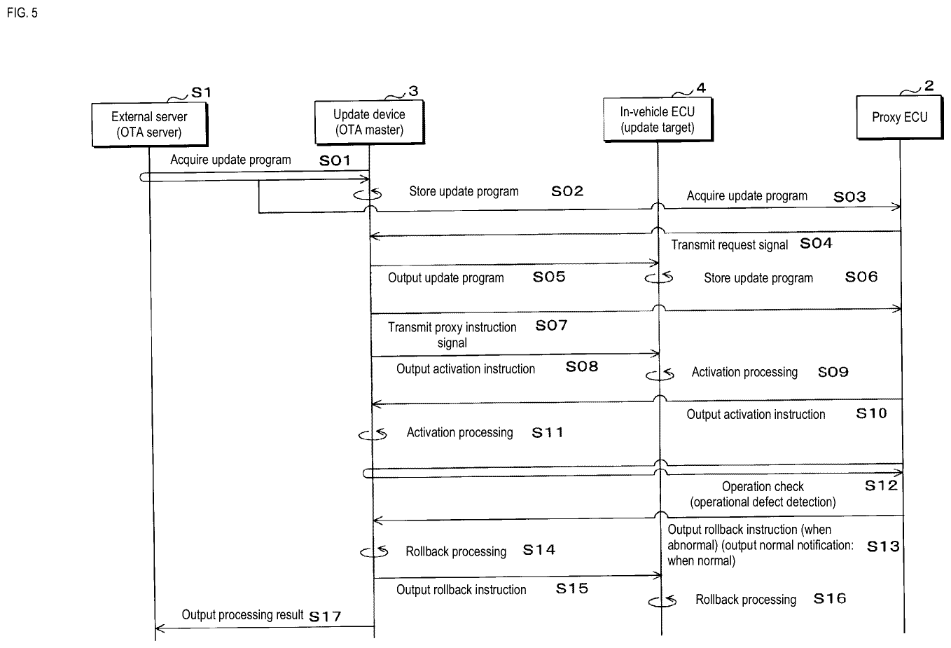

FIG. 5 is an explanatory diagram illustrating an example of a processing flow (sequence) by the update device 3, the in-vehicle ECU 4 and the proxy ECU 2 to be updated, and the like according to the first embodiment. When executing processing related to the program update in the update device 3 (OTA master) and the in-vehicle ECU 4 to be updated using the update program, each of processing sequences of the external server S1 (OTA server), the update device 3 (OTA master), the in-vehicle ECU 4 to be updated (a target ECU), and the proxy ECU 2 will be described.

The update device 3 acquires the update program from the external server S1 (S01). The update device 3 accesses the external server S1 using, for example, an identification number (VIN: Vehicle Identification Number) of the vehicle C (own vehicle) on which the update device itself is mounted, and acquires from the external server S1 the package including the update program to be applied to the own vehicle. The package includes, for example, package information (campaign information) that is information on the program update, information (target information) on the update device 3 and the in-vehicle ECU 4 that are the update targets, and the update program to be applied to the update device 3 and in-vehicle ECU 4 that that are the update targets of the program.

The update device 3 stores the update program for its own device (S02). The update device 3 stores the update program for its own device in the storage area (storage unit) that is the non-operation side. The update device 3 includes the first storage unit and the second storage unit as the storage areas for storing the program, and for example, when the program currently being executed is in the first storage unit, the first storage unit corresponds to the operation side. In this case, a program of an earlier version (old version) than the program currently being executed is stored as a backup in the second storage unit that is the non-operation side. The update device 3 stores the update program for its own device obtained from the external server S1 in the second storage unit that is the non-operation side. Thus, the program currently being executed can be maintained in a state stored in the first storage unit without being overwritten.

The proxy ECU 2 acquires the update program from the external server S1 (S03). As described above, the proxy ECU 2 is connected to the out-vehicle side communication line 52 in the same way as the out-vehicle communication device 1, and when the update program is transmitted from the external server to the update device 3 via the out-vehicle side communication line 52, the proxy ECU 2 can also receive the update program without going through the update device 3. For example, when the update program is transmitted from the external server using multicast, the proxy ECU 2 and a plurality of communication nodes via the update device 3 may simultaneously acquire the update program. In this way, when the update device 3 acquires the update program, the proxy ECU 2 acquires the update program by checking communication between the out-vehicle communication device 1 and the update device 3. Note that although in the present embodiment, the proxy ECU 2 receives the update program without going through the update device 3, the present disclosure is not limited to this, and the proxy ECU 2 may acquire the update program from the update device 3.

The proxy ECU 2 transmits the request signal to the update device 3 (S04). The proxy ECU 2 determines whether the update device 3 is a target for update based on the acquired update program, and if the update device 3 is the target for update, the proxy ECU 2 outputs the request signal for requesting the update device to start the proxy processing for the update device 3.

The update device 3 outputs (transmits) the update program for the in-vehicle ECU 4 to the in-vehicle ECU 4 to be updated (S05). The update device 3 identifies the in-vehicle ECU 4 to be updated based on the target information acquired from the external server S1, and transmits the update program for the in-vehicle ECU 4 to the identified in-vehicle ECU 4.

The in-vehicle ECU 4 to be updated stores the update program acquired (received) from the update device 3 (S06). Like the update device 3, the in-vehicle ECU 4 to be updated stores the acquired update program on the non-operation side, so that it is possible to prevent the program currently being executed (stored in the operation side) from being overwritten.

The update device 3 transmits the proxy instruction signal to the proxy ECU 2 (S07). When the update device 3 has acquired (received) the request signal from the proxy ECU 2, the update device 3 transmits the proxy instruction signal to the proxy ECU 2 that transmitted the request signal, indicating the instruction to execute the proxy processing for the update device 3.

The proxy ECU 2 that has responded to the proxy instruction signal from the update device 3 is triggered, for example, by the proxy instruction signal to start a routine of the proxy processing for the update device 3. Thus, the proxy ECU 2 functions as an activation instruction unit that issues the activation instruction to the update device 3, and as an abnormality detection unit and a recovery control unit for the update device 3 that has executed the activation processing.

The update device 3 outputs (transmits) the activation instruction to the in-vehicle ECUs 4 to be updated (S08). The update device 3 outputs the activation instruction to each of the in-vehicle ECUs 4 to be updated, and causes the in-vehicle ECUs 4 to execute the activation processing.

The in-vehicle ECU 4 to be updated executes the activation processing in response to the activation instruction output from the update device 3 (S09). The in-vehicle ECU 4 that has acquired (received) the activation instruction output from the update device 3 executes the activation processing to apply the update program by restarting the storage area in which the update program is stored as the operation side.

The proxy ECU 2 outputs (transmits) the activation instruction to the update device 3 (S10). The update device 3 executes the activation processing in response to the activation instruction output from the proxy ECU 2 (S11). The update device 3 that has acquired (received) the activation instruction output from the proxy ECU 2 executes the activation processing to apply the update program by restarting the storage area in which the update program is stored as the operation side.

The proxy ECU 2 executes processing of the operation check (operational defect detection) on the update device 3 that has executed the activation processing (S12). The proxy ECU 2 (abnormality detection unit) monitors, for example, whether there is a periodic autonomous transmission frame transmitted from the update device 3 after the activation processing, and determines that the update device 3 after the activation process is normal if it receives the autonomous transmission frame, and determines that the update device 3 is abnormal (the operational defect is detected) if it cannot receive the frame. Alternatively, the proxy ECU 2 may transmit a test signal for detecting operational defects to the update device 3 after the activation processing, and executes the operation check (operational defect detection) of the update device 3 based on whether a response signal to the test signal is received. That is, the proxy ECU 2 may determine that the update device 3 is normal if it receives the response signal to the test signal from the update device 3 after the activation processing, and determine that the update device 3 is abnormal (the operational defect is detected) if it cannot receive the response signal.

The proxy ECU 2 outputs (transmits) a normal notification or a rollback instruction to the update device 3 depending on an operation check result (S13). If the operation check result is normal, the proxy ECU 2 outputs (transmits) the normal notification to the update device 3. If the operation check result is abnormal (the operational defect is detected), the proxy ECU 2 (recovery control unit) outputs (transmits) the rollback instruction to the update device 3. The rollback instruction corresponds to an abnormality notification indicating that the activation processing (application of the update program) in the update device 3 has failed.

The update device 3 executes the rollback processing based on the rollback instruction output from the proxy ECU 2 (S14). The update device 3 that has received the rollback instruction output from the proxy ECU 2 executes the rollback processing by restarting to execute the program (original program) that was running before the update program was applied (before the activation processing). The original program is stored (saved) as the backup in the storage area (non-operation side) different from the storage area (operation side) in which the update program is stored. By restarting with the storage area in which the original program is stored as the operation side, the update device 3 can execute the rollback processing with the storage area in which the update program is stored as the non-operation side.

The update device 3 outputs (transmits) the rollback instruction to the in-vehicle ECU 4 to be updated (S15). When the update device 3 executes the rollback processing on its own device, it also outputs the rollback instruction to the in-vehicle ECU 4 to be updated, to eliminate inconsistencies that occur between the update device 3 and the in-vehicle ECU 4 due to differences in program versions, or the like.

When the update device 3 does not execute the rollback processing of its own device, that is, even when the activation processing of its own device has been successfully completed, if the activation processing fails in any of the in-vehicle ECUs 4 to be updated, the update device 3 outputs (transmits) the rollback instruction to all the in-vehicle ECUs 4 to be updated. In this case, the update device 3 further executes the rollback processing of its own device. This makes it possible to eliminate inconsistencies that occur between the update device 3 and the in-vehicle ECUs 4 due to the differences in program versions, or the like.

The in-vehicle ECU 4 to be updated executes the rollback processing in response to the rollback instruction output from the update device 3 (S16). Like the update device 3, the in-vehicle ECU 4 to be updated switches a correspondence between the operation side and the non-operation side in the storage area in which the update program is stored and the storage area in which the original program is stored, and restarts, to execute the rollback processing to return to an execution environment of the original program.

The update device 3 outputs (transmits) a processing result related to the update program to the external server S1 (S17). As a result of the processing related to the update program, the update device 3 outputs (transmits) to the external server S1 an update success notification indicating that the application of the update program to the update device 3 and the in-vehicle ECU 4 that are the update targets has been successful, or an update failure notification indicating that the application of the update program has failed and been rolled back. The update device 3 may output the result of the processing related to the update program to the display device and cause the display device to display the processing result. The update device 3 may modify the vehicle configuration information related to the update device 3 and the in-vehicle ECU 4 that are the update targets based on the processing result of the update program.

In the present embodiment, the proxy ECU 2 proxies the program update processing in the update device 3, but the present disclosure is not limited to this, and the proxy ECU 2 may proxy all of the program update processing in the update device 3 and the in-vehicle ECU 4 that are the update targets.

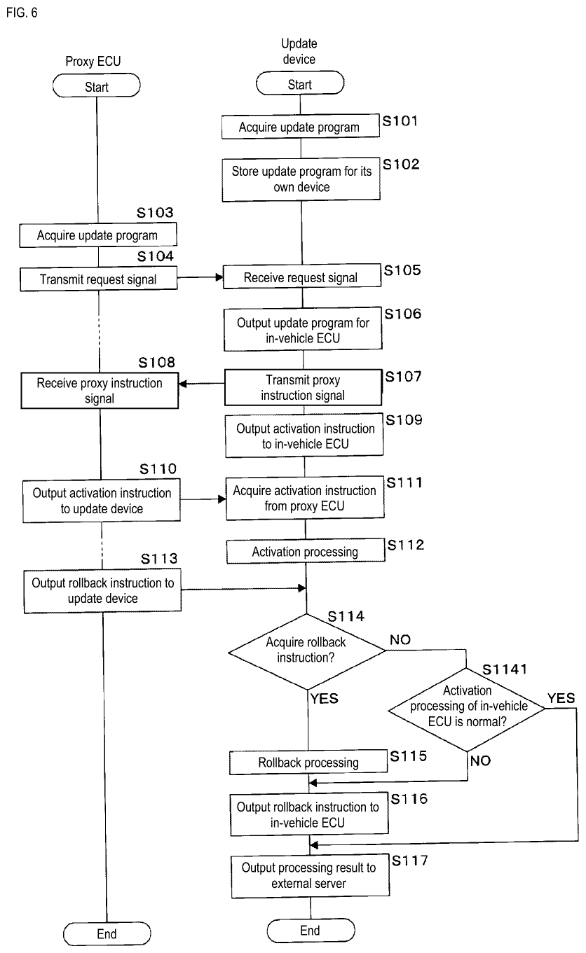

FIG. 6 is a flowchart illustrating an example of the processing by the control unit 20 of the proxy ECU 2 and the control unit of the update device 3 according to the first embodiment. The control unit of the update device 3 steadily executes the following processing, for example, when the vehicle C is in a stopped state (the IG switch is turned off).

The control unit of update device 3 acquires the update program from the external server S1 (S101). The control unit of update device 3 stores the update program for its own device (S102). The control unit of update device 3 acquires from external server S1 the package including the update program to be applied to its own device and in-vehicle ECU 4, and stores the update program for its own device in the storage area on the non-operation side. For example, when a first storage unit 231 is the operation side and stores the program currently being executed, the control unit of update device 3 stores the update program for its own device in a second storage unit 232 that is the non-operation side.

The control unit 20 of the proxy ECU 2 acquires the update program from the external server S1 (S103). When the control unit 20 of the proxy ECU 2 determines that the update device 3 is the update target based on the acquired update program, it transmits the request signal to the update device 3 (S104). The control unit of the update device 3 receives the request signal from the proxy ECU 2 (S105).

The control unit of the update device 3 outputs (transmits) the update program for the in-vehicle ECU 4 to the in-vehicle ECU 4 to be updated (S106). The control unit of the update device 3 identifies the in-vehicle ECU 4 to be updated based on the target information included in the package acquired from the external server S1, and transmits the update program for the in-vehicle ECU 4 to the identified in-vehicle ECU 4.

The control unit of the update device 3 transmits the proxy instruction signal to the proxy ECU 2 (S107), and the proxy ECU 2 receives the proxy instruction signal from the update device 3 (S108). Then, the control unit of the update device 3 may stop power supply to the in-vehicle communication unit 22 connected to the in-vehicle side communication line 51 (segment) to which the in-vehicle ECU 4 to be updated is not connected, to reduce power consumption by the in-vehicle communication unit 22. A relay, which controls supply and cut-off of power to the in-vehicle communication unit 22, is provided for each in-vehicle communication unit 22 included in the update device 3, and the control unit of the update device 3 turns off the relay. This may stop power supply to the in-vehicle communication unit 22 connected to the in-vehicle side communication line 51 (segment) to which the in-vehicle ECU 4 to be updated is not connected. The program update processing needs to be executed while the engine is stopped, and thus consumes power of a power storage device such as a lead battery, however, by stopping energization to the in-vehicle communication unit 22, an amount of power consumption can be reduced.

The control unit of the update device 3 outputs (transmits) the activation instruction to the in-vehicle ECU 4 to be updated (S109). The control unit of the update device 3 outputs the activation instruction to each of the in-vehicle ECUs 4 to be updated, and causes the in-vehicle ECUs 4 to execute the activation processing.

The control unit 20 of the proxy ECU outputs the activation instruction to the update device 3 (S110), and the control unit of the update device 3 acquires (receives) the activation instruction from the proxy ECU 2 (S111). The control unit of the update device 3 executes the activation processing in response to the activation instruction (S112). The control unit of the update device 3 executes (applies) the update program by executing the activation processing, and upgrades the control program P executed by its own device. The control unit of the update device 3 executes the update program, to output predetermined data (frames or messages) by broadcast or multicast, for example, periodically or cyclically.

The proxy ECU 2 determines whether it has received the predetermined data periodically transmitted from the update device 3 that has executed the activation processing (applied the update program), and determines whether the operational defect has occurred in the update device 3 after the activation processing based on the determination result. Alternatively, the proxy ECU 2 may transmit the test signal to the update device 3 that has executed the activation processing (applied the update program), and determine whether the operational defect has occurred in the update device 3 after the activation processing based on whether there is a response from the update device 3. When the proxy ECU 2 determines that the operational defect has occurred in the update device 3 after the activation processing, it outputs (transmits) the rollback instruction to the update device 3 (S113). When the proxy ECU 2 determines that no operational defect has occurred in the update device 3 after the activation processing, it outputs (transmits) the normal notification to the update device 3.

The control unit of the update device 3 determines whether the rollback instruction has been acquired (received) from the proxy ECU 2 (S114). If the rollback instruction has been acquired from the proxy ECU 2 (S114: YES), the control unit of the update device 3 executes the rollback processing (S115). If the control unit of the update device 3 acquires the rollback instruction from the proxy ECU 2, it executes the rollback processing by restarting to execute the program (original program) that was running before the update program was applied (before the activation processing).

If the rollback instruction is not received from the proxy ECU 2 (S114: NO), the control unit of the update device 3 determines whether the activation processing of all the in-vehicle ECUs 4 to be updated has been executed normally (S1141). If the control unit of the update device 3 does not receive the rollback instruction from the proxy ECU 2, it determines that the application of the update program (activation processing) in its own device has been completed normally. Alternatively, the control unit of the update device 3 may determine that the application of the update program (activation processing) in its own device has been completed normally if it acquires the normal notification from the proxy ECU 2. Then, the control unit of the update device 3 determines whether the application of the update program (activation processing) in all the in-vehicle ECUs 4 to be updated has been completed normally. The control unit of the update device 3 may transmit, for example, test communication data to each of all the in-vehicle ECUs 4 to be updated, and determine whether the activation processing of each of the in-vehicle ECUs 4 has been completed normally based on whether response data to the communication data has been received.

If it is determined that the activation processing of all the in-vehicle ECUs 4 to be updated was not executed normally, that is, if it is determined that the activation processing of even one of the in-vehicle ECUs 4 to be updated has not been executed normally (S1141: NO), or after executing the rollback processing of the update device itself (S115), the rollback instruction is output (transmitted) to the in-vehicle ECU 4 to be updated (S116). The in-vehicle ECU 4 to be updated executes the rollback processing in response to the rollback instruction output from the update device 3.

If it is determined that the activation processing of all the in-vehicle ECUs 4 to be updated has been executed normally (S1141: YES), or after outputting the rollback instruction to the in-vehicle ECUs 4 to be updated (S116), the control unit of the update device 3 outputs (transmits) the processing result related to the update program to the external server S1 (S117). The control unit of the update device 3 may output the processing result related to the update program to the external server S1 and the display device, and further modify the vehicle configuration information related to the update device 3 and the in-vehicle ECUs 4 that are the update targets based on the processing result. In addition, after outputting (transmitting) the update program for the in-vehicle ECU 4 to the in-vehicle ECU 4 to be updated, the processing unit of the update device 3 may determine whether the activation processing of all the in-vehicle ECUs 4 to be updated has been executed normally, and transmit the proxy instruction signal to the proxy ECU 2 if the activation processing has been executed normally.

### Second Embodiment

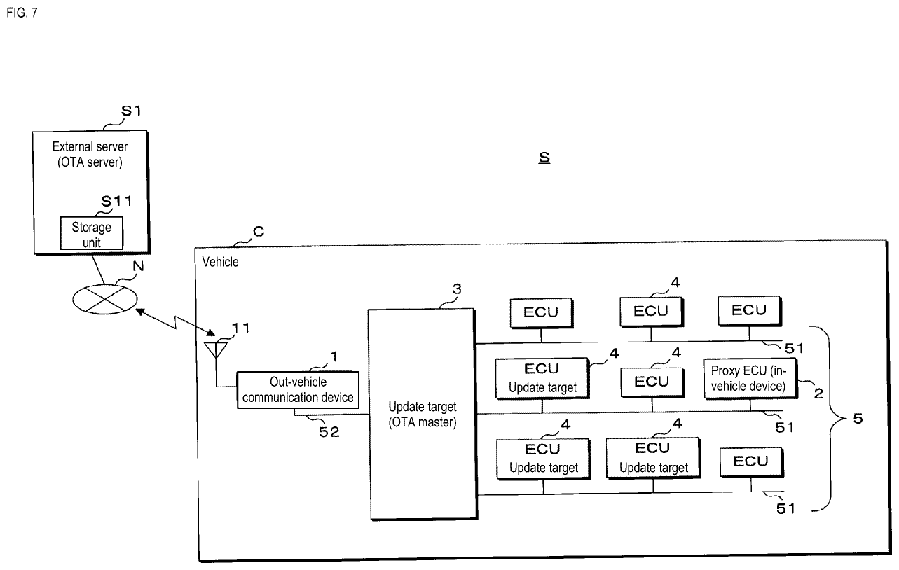

FIG. 7 is a schematic diagram illustrating an example of the configuration of the in-vehicle update system S according to a second embodiment. The proxy ECU according to the second embodiment is connected to the in-vehicle side communication line 51. Further, the update device 3 according to the first embodiment does not retain the communication relay function when updating its own device, and the proxy ECU 2 and the in-vehicle ECU 4 cannot communicate with each other, but the present disclosure is not limited to this. The update device 3 according to the present embodiment retains the communication relay function when updating its own device, and the proxy ECU 2 and the in-vehicle ECU 4 connected to the in-vehicle side communication line 51 (segment) different from the in-vehicle side communication line 51 (segment) to which the proxy ECU is connected can communicate via the relay function.

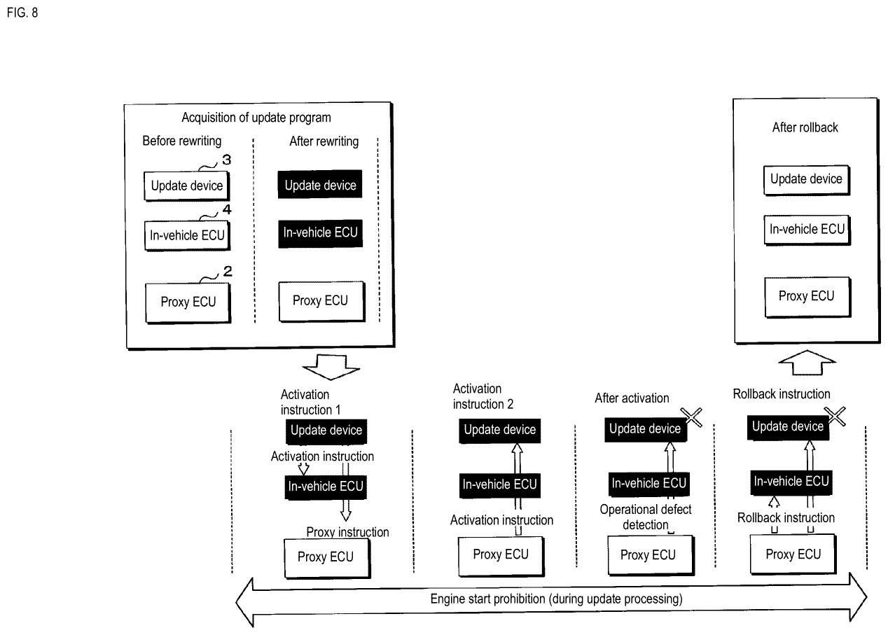

FIG. 8 is an explanatory diagram illustrating an example of the state transitions of the update device 3, the in-vehicle ECU 4 and the proxy ECU 2 to be updated, and the like in the program update processing according to the second embodiment. When the proxy ECU 2 detects the operational defect in the update device 3 after the activation processing (operational defect: present), it transmits the rollback instruction to the update device 3, and also transmits the rollback instruction to the in-vehicle ECU 4 via the relay function of the update device 3. As illustrated in FIG. 8, according to the present embodiment, it is possible to execute the rollback processing of the update device 3 and the in-vehicle ECU 4 with a one-stage rollback instruction from the proxy ECU 2.

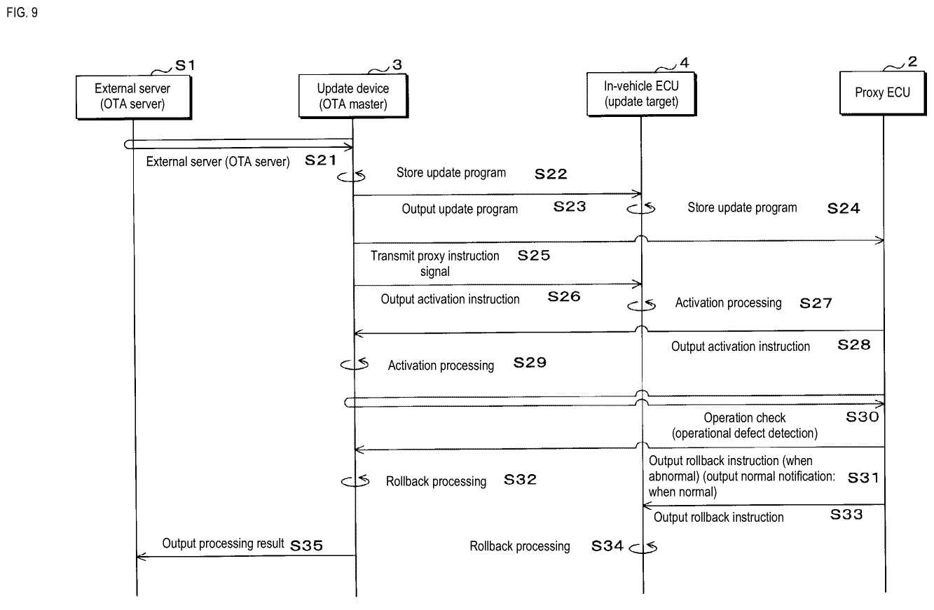

FIG. 9 is an explanatory diagram illustrating an example of the processing flow (sequence) by the update device 3, the in-vehicle ECU 4 and the proxy ECU 2 to be updated, and the like according to the second embodiment. S21 to S32 are similar processing to S01, S02, and S05 to S14 in FIG. 5. At the same time as or after outputting the rollback instruction to the update device 3 (S31), the proxy ECU 2 outputs the rollback instruction to the in-vehicle ECU 4 (S33). The in-vehicle ECU 4 executes the rollback processing in response to the rollback instruction output from the proxy ECU 2 (S34). The update device 3 outputs (transmits) the processing result related to the update program to the external server S1 (S35).

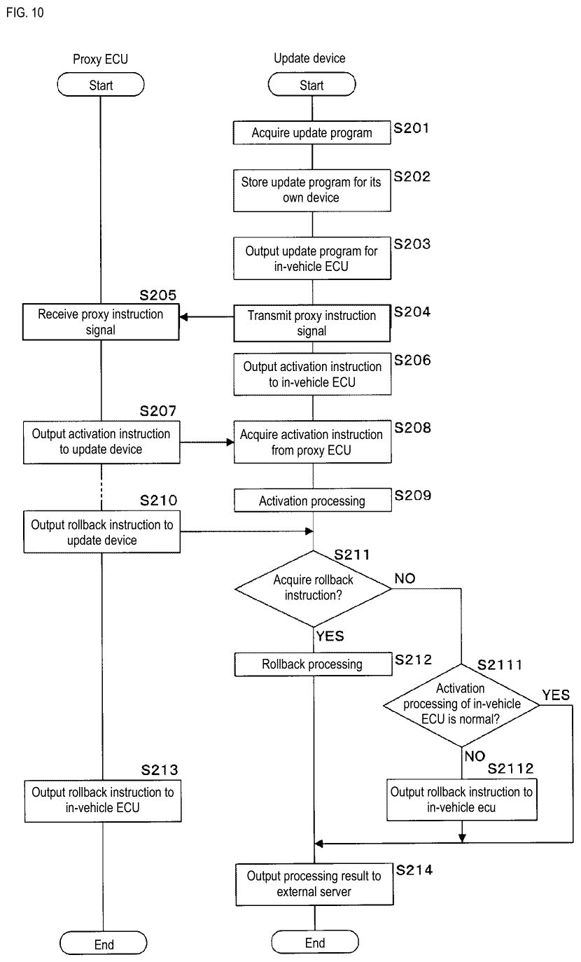

FIG. 10 is a flowchart illustrating an example of the processing of the control unit 20 of the proxy ECU 2 and the control unit of the update device 3 according to the second embodiment. S201 to S211 are similar processing to S101, S102, and S106 to S114 in FIG. 6. The control unit 20 of the proxy ECU 2 outputs the rollback instruction to the update device 3 (S210), and then outputs the rollback instruction to the in-vehicle ECU 4 via the relay function of the update device 3 (S213).

If the control unit of the update device 3 does not acquire the rollback instruction from the proxy ECU 2 (S211: NO), it determines whether the activation processing of all the in-vehicle ECUs 4 to be updated has been executed normally (S2111). If it is determined that the activation processing of all the in-vehicle ECUs 4 to be updated has been executed normally (S2111: YES), the control unit of the update device 3 outputs (transmits) the processing result related to the update program to the external server S1 (S214). If it is determined that the activation processing of all the in-vehicle ECUs 4 to be updated has not been executed normally, that is, if it is determined that the activation processing of even one of the in-vehicle ECUs 4 to be updated has not been executed normally (S2111: NO), the processing unit of the update device 3 outputs the rollback instruction to the in-vehicle ECUs 4 (S2112), and outputs (transmits) the processing result related to the update program to the external server S1 (S214).

According to the above processing, if the activation processing of the update device 3 is not executed normally, the proxy ECU 2 outputs the rollback instruction to the update device 3 and the in-vehicle ECU 4, and if the activation processing of the update device 3 is executed normally and the activation processing of the in-vehicle ECU 4 is not executed normally, the update device 3 outputs the rollback instruction to the in-vehicle ECU 4. This makes it possible to execute the rollback processing efficiently depending on the situation.

The embodiments disclosed herein are illustrative in all respects and should be considered as not limiting the present disclosure. Technical features described in the embodiments can be combined with each other, and the scope of the present disclosure is intended to include all modifications within the scope of the claims and equivalents to the scope of the claims.

Regarding the above embodiments including the first and second embodiments, the following supplementary note is further disclosed.

### Supplementary Note 1

An in-vehicle update system including: an update device that executes processing for updating a program of an in-vehicle ECU mounted on a vehicle with an update program acquired from an external server outside the vehicle; and an in-vehicle device communicably connected to the update device, in which the in-vehicle device including a control unit that executes processing for updating a program in the update device, and the control unit proxies at least a part of the processing for updating the program, which is executed in the update device when the update device is included in a target to be updated by the update program.

In this aspect, the update device can smoothly execute the program update processing in the update device by causing the in-vehicle device (proxy ECU) to take charge of the program update (such as application of the update program) in the update device itself.

1. An in-vehicle device communicably connected to an update device that executes processing for updating a program of an in-vehicle ECU mounted on a vehicle with an update program acquired from an external server outside the vehicle, the in-vehicle device comprising
a control unit configured to execute processing for updating a program in the update device, wherein
the control unit executes proxy processing of at least a part of the processing executed in the update device when the update device is included in a target to be updated by the update program.

2. The in-vehicle device according to claim 1, wherein the proxy processing includes activation processing for applying the update program acquired by the update device to the update device itself.

3. The in-vehicle device according to claim 1, wherein the proxy processing includes rollback processing depending on a result of activation processing.

4. The in-vehicle device according to claim 1, wherein a storage unit of the update device stores in advance information for identifying the in-vehicle device as a proxy ECU that executes the proxy processing.

5. The in-vehicle device according to claim 1, wherein the control unit acquires an instruction signal indicating an instruction to execute the proxy processing from the update device, and starts the proxy processing in response to the acquired instruction signal.

6. The in-vehicle device according to claim 1, wherein
the proxy processing includes processing for updating the program of the in-vehicle ECU,
the update device has a relay function for relaying data transmitted and received between in-vehicle ECUs, and
the control unit changes the processing for updating the program of the in-vehicle ECU depending on whether the update device maintains the relay function when the update device is included in the target to be updated by the update program.

7. The in-vehicle device according to claim 1, wherein
the update device is connected to a communication line on the external server side and a communication line on the in-vehicle ECU side, and
the in-vehicle device is connected to the communication line on the external server side.

8. The in-vehicle device according to claim 7, wherein the control unit acquires the update program from the external server without going through the update device, and outputs a request signal to request the update device to start the proxy processing based on the acquired update program.

9. The in-vehicle device according to claim 7, wherein
the communication line on the external server side is connected to an out-vehicle communication device for wireless communication with the external server, and
the in-vehicle device is included in the out-vehicle communication device.

10. A program that causes a computer communicably connected to an update device that executes processing for updating a program of an in-vehicle ECU mounted on a vehicle with an update program acquired from an external server outside the vehicle to execute processing for updating a program in the update device, and
causes the computer to execute processing for proxying at least a part of the processing for updating the program, which is executed in the update device when the update device is included in a target to be updated by the update program.

11. A program updating method comprising:
causing a computer communicably connected to an update device that executes processing for updating a program of an in-vehicle ECU mounted on a vehicle with an update program acquired from an external server outside the vehicle to execute processing for updating a program in the update device; and
causing the computer to execute processing for proxying at least a part of the processing for updating the program, which is executed in the update device when the update device is included in a target to be updated by the update program.
